(19) United States
(12) Patent Application Publication
(10) Pub. No.: US 2015/0374576 A1
(43) Pub. Date: Dec. 31, 2015

(54) Self-Massage Device

(71) Applicant: Gideon Dagan, Los Angeles, CA (US)

(72) Inventor: Gideon Dagan, Los Angeles, CA (US)

(21) Appl. No.: 14/838,207

(22) Filed: Aug. 27, 2015

Related U.S. Application Data
(63) Continuation-in-part of application No. 13/484,144, filed on May 30, 2012, now Pat. No. 9,168,196.
(60) Provisional application No. 62/207,082, filed on Aug. 19, 2015.
(60) Provisional application No. 61/532,472, filed on Sep. 8, 2011.
(60) Provisional application No. 61/533,109, filed on Sep. 9, 2011.

(51) Int. Cl. A61H 7/00; A61H 15/00

(52) U.S. Cl. CPC A61H 7/003; A61H 15/00; A61H 15/0092; A61H 2015/0035

(57) ABSTRACT

A massage device comprises a main body having a body-contacting head point adjacent one end and a handle region adjacent the other end, that permits the user to reach the back of his/her body with the head end when the handle region is at the user's front or side. A rest pivot extends from the main body and terminates at a distal end in a support-contacting face. The rest pivot is positioned so that when the massage device is sandwiched between a support surface and the user with the head point in contact with the user's body and the handle region positioned for contact by the user's hand, the user's body weight can be controllably and adjustably applied against the head point and also stabilizes the rest pivot on the support.

The head point contacting the user's body can be one of a number of releasably securable head points.

The rest pivot can be configured so as to be positioned where desired by the user or removed entirely.

The handle region can include a roller positioned to enable the user can roll the roller along muscles to be relaxed using one hand when the rest pivot is sandwiched between the support surface and the user. The handle region can be configured to be detachable from the remainder of the massage device for grasping between the user's hands to roll the roller along muscles to be relaxed.

### CLAIM OF PRIORITY

This application is a continuation-in-part of co-pending U.S. patent application Ser. No. 13/484,144 filed May 20, 2012, the priority of which is claimed, which claims the benefit of Provisional U.S. Patent Application 61/532,472 filed Sep. 8, 2011 and Provisional U.S. Patent Application 61/533,109 filed Sep. 9, 2011, the priorities of which are claimed herein.

This application also claims priority of U.S. Provisional Patent Application No. 62/207,082 filed Aug. 19, 2015.

### Incorporation by Reference

The content of my U.S. patent application Ser. No. 13/484,144 filed May 20, 2012 is hereby incorporated by reference.

### FIELD OF THE INVENTION

This invention is directed to a self-massage device which acts upon a user's body by moving or massaging a portion of the body to produce a therapeutic effect.

### BACKGROUND

The massage apparatus herein is intended to aid in a self-massage of regions of the body whether the regions are accessible to the user, or nearly or completely inaccessible, when using hands alone. The massage apparatus herein provides such aid by applying pressure to treat sore muscles and trigger points.

Known devices commonly used in self-massaging the back and other hard to reach areas tend to be held in the user's hands and pulled to the place of tension. Examples of such devices are trigger point massage devices such as the “AccuMassager Trigger Point Massager” offered by Body Back Company at www.bodyback.com, the “Backnobber Massager 2” offered by The Pressure Positive at www.backnobber-store.com, the “SoloMAX self-massage tool” offered by Kelly Kinetics, the “Thera Cane” offered by Thera Cane at www.theracane.com, and the “Body Back Buddy Jr. Trigger Point Travel Massager”, the “Body Back Buddy Trigger Point Massager”, and the “Body Back Mini Trigger Point Travel Massager” offered by Body Back at www.bodyback.com.

Such massage devices require the user to hold the device over his/her shoulder in order to direct the body-contacting tip of the device to the point of massage, and then move the device by pushing, pulling and otherwise manipulating it with his/her arms and shoulders in order to apply pressure to the problem point

A second known device is essentially a generally cylindrical roller that is held at each end by the user and rolled, in the fashion of a rolling pin, along the muscles to be relaxed, soothed and/or loosened.

### SUMMARY

This massage device herein is a single massage device that allows the user to self-massage regions of his/her body whether or not the regions are accessible to the user when using hands alone. The massage device comprises a main body having a body-contacting head point adjacent one end and a manually grippable handle region adjacent the other end, the body being shaped to permit a user to reach the back of his/her body with the head end point when the handle region is at the user's front or side,

The massage device includes a rest pivot extending from the main body and terminating at a distal end in a support-contacting face. The rest pivot is positioned with respect to the head point so that when the rest pivot is sandwiched between a support surface and the user with the head point in contact with the user's body and the handle region positioned for contact by the user's hand, (a) the user's bodyweight applied to the rest pivot generally stabilizes the rest pivot against sliding movement on the support surface, (b) the user's body weight can be controllably and adjustably applied against the head point by the user, and (c) any pivoting force about the rest pivot applied by the user's hand to the handle region is substantially less than the force exerted against the user's body by the head point. Examples of rest pivots are illustrated and described in my co-pending U.S. patent application Ser. No. 13/484,144 filed May 20, 2012 and in my Provisional U.S. Patent Application 61/532,472 filed Sep. 8, 2011 and in my Provisional U.S. Patent Application 61/533,109 filed Sep. 9, 2011, the contents of which are all hereby incorporated by reference.

The head point contacting the user's body can be any of a number of tissue-compressing surfaces such as a convex surface, a rollable ball or a ridged surface, or it can be a back-scratcher, a lotion applicator, a wash cloth or a brush. Thus, while referred to as a “massage device” for convenience, the device herein need not be used for, or dedicated to, massage. Optionally, the massage device and least a plurality of the alternative head points are configured so that those head points are releasably securable to the massage device.

Another preferred feature provides a rest pivot that is formed as a sleeve (or as part of a sleeve) configured to be slid along the main body of the massage device so that the rest pivot can be positioned where desired by the user or removed entirely.

The rest pivot aids the user by providing stable positioning of the head point with respect to the user's body during use of the device so that the particular head point shape carried by the massage device can be used effectively and accurately in an easily controllable manner while requiring little upper body strength or joint mobility.

In accordance with another preferred feature, the handle region includes a roller portion disposed about a central axis and having an axially-extending, skin-contacting roller surface mounted for rotation about said axis. When the rest pivot is sandwiched between the support surface and the user during use of the massage device, it provides stability that enables the user to roll the roller surface along the muscles to be relaxed with one hand. The handle region can be configured to be detachable from the remainder of the massage device in such a way that the roller portion can be rolled along the muscles to be relaxed, soothed and/or loosened while the detached handle region is grasped between the user's hands.

Other details and features of the invention will become apparent from the following detailed description, including the annexed drawings, which discloses a preferred embodiment of the invention.

### DESCRIPTION OF THE DRAWING

In the drawing,

FIG. 1 is a side elevation view of a prior art self-massage device of the so-called “trigger point” release type;

FIG. 2 is a side elevation view of an embodiment of a self-massage device illustrated and described in my U.S. patent application Ser. No. 13/484,144 filed May 20, 2012;

FIG. 3 is a side elevation view in schematic of a preferred embodiment of a massage device constructed in accordance with the invention;

FIG. 4 is a top plan view in schematic of the preferred massage device in use;

FIGS. 5 and 6 are each a right side elevation view in schematic of the preferred massage device of FIG. 3 in use;

FIG. 7 is a right side elevation view in schematic of a variation of the preferred massage device of FIG. 3, showing its handle region detached;

FIG. 8 is an enlarged fragmentary sectional view taken along line 8-8 in FIG. 7;

FIG. 9 is an illustration in schematic of a user utilizing the handle portion of the massage device of FIG. 7 along muscles to be relaxed, soothed and/or loosened;

FIG. 10 is a side elevation view in partial section of the device's handle region of FIG. 7;

FIG. 11 is a side elevation view in partial section of an alternative handle region for the massage devices of FIGS. 3 and 7;

FIGS. 12 and 13 are cross-sectional views of the handle portion in FIG. 11, respectively taken along lines 12-12 and 13-13 therein;

FIG. 14 is a vertical section of roller elements in FIG. 11, taken along line 14-14 therein;

FIGS. 15-20 are fragmentary side elevation views showing examples of alternative rest pivot locations and optional rest pivots for use with the massage devices of FIGS. 2 and 3, FIG. 15 being in partial section;

FIG. 21 is a fragmentary side sectional view of an optional rest pivot feature;

FIG. 22 is a fragmentary right side elevation view showing examples of optional rest pivots constructed in accordance with the invention;

FIGS. 23-27 are fragmentary right side elevation views in section showing examples of optional rest pivots constructed in accordance with the invention;

FIG. 28 is a fragmentary side elevation view in partial section illustrating an alternative head point that can be used as part of the massage devices of FIGS. 2 and 3; and

FIGS. 29-31 are fragmentary side elevation views illustrating other alternative head points that can be used as part of the massage devices of FIGS. 2 and 3.

### DETAILED DESCRIPTION OF THE PREFERRED EMBODIMENT

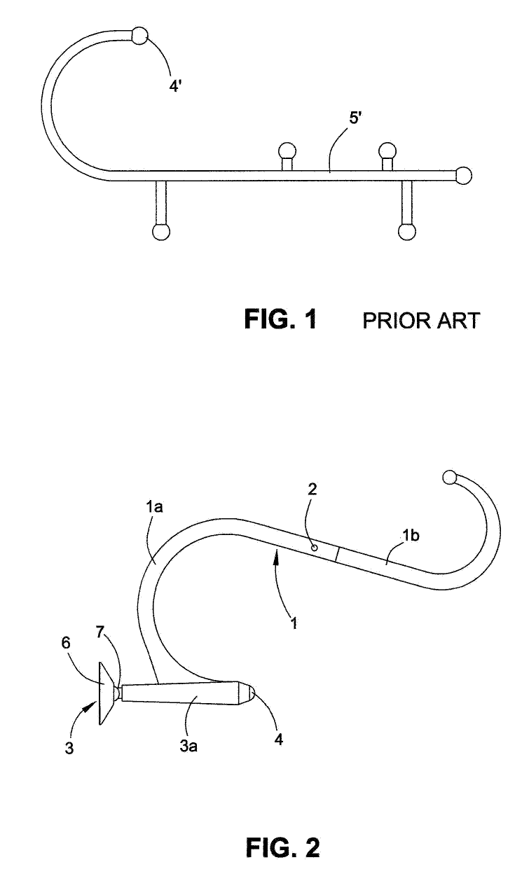

FIG. 1 is a side elevation view of a prior art device of the trigger-point release type. The device is generally “J”-shaped with a generally linear stem portion forming a handle region 5′ and a curved region extending from the stem portion and terminating in a body-contacting head point 4′ at the other end (the “head end”).

FIG. 2 is a side elevation view of a self-massage device illustrated and described in my U.S. patent application Ser. No. 13/484,144 filed May 20, 2012 The illustrate massage device comprises a generally “S”-shaped main body 1 having a body-contacting head point 4 at one end (the “head end”), and a handle region adjacent the other end.

As illustrated and described in my U.S. patent application Ser. No. 13/484,144 (hereinafter, “the '144 Application”), the contents of which are incorporated by reference herein, the main body 1 can formed from a single integral piece of plastic, wood or metal or can be formed from multiple reversibly detachable parts. As illustrated in FIG. 2, and described in more detail in the foregoing patent application, the main body 1 is preferably bifurcated into two body segments 1a, 1b that are coupled together by a locking mechanism 2 that allows the main body to be taken apart for convenient storage or travel and thereafter securely reassembled.

As illustrated in FIGS. 4-6 herein, the main body 11 of the massage device is supported against a wall by a rest pivot 3 that allows the main body 11 to swivel and turn without slipping off the wall when the user's bodyweight is applied to the rest pivot during use. The preferred rest pivot 3 includes a base 6 having a wall-contacting face with a wall-contacting surface. The base 6 illustrated in FIGS. 4-6 is generally cup-shaped, with a wall contacting face that can be generally planar or generally concave (i.e., similar to a suction cup's shape). Those of ordinary skill in the art will recognize that the user can use a floor, a chair's back while sitting, a tree, a car or any other suitable support surface in lieu of a wall, and all such support surfaces are to be deemed equivalent to the term “wall”, which is used herein for simplicity.

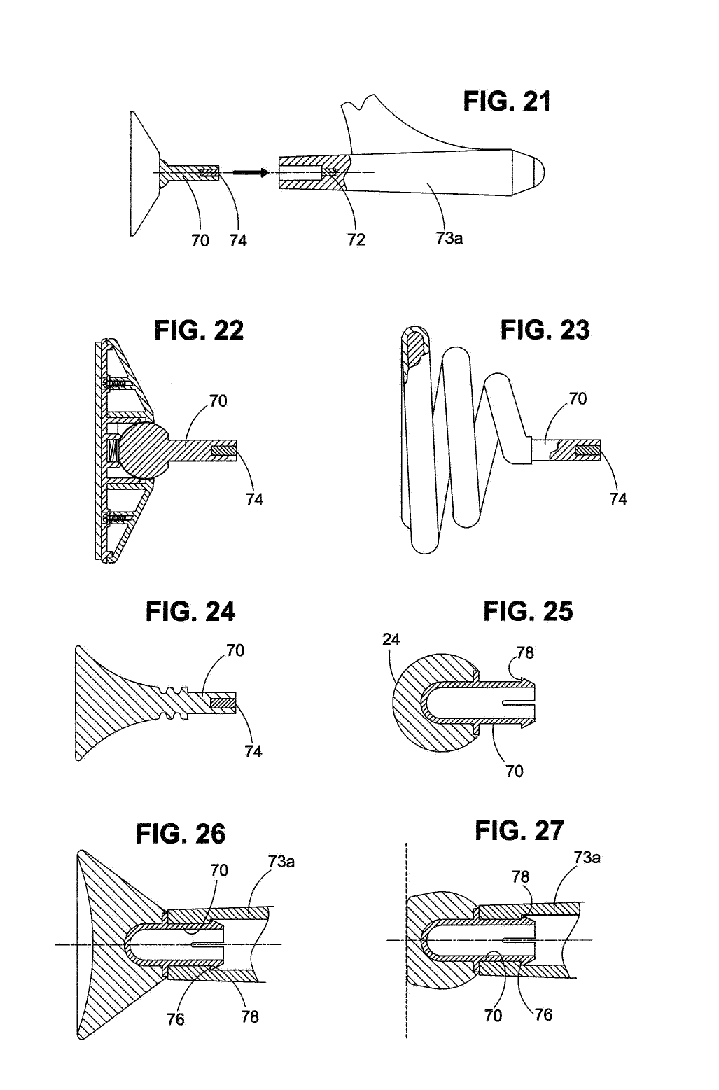

At least the wall-contacting surface of the rest pivot's base 6 is preferably made from a non-abrasive and/or resilient material: for example, latex rubber, plastic, foam, metal and combinations thereof. The illustrated rest pivot further includes an arm 3a pivotably coupled to the base by a ball and socket mechanism 70 (FIG. 22), or other pivot mechanism, to enable the body 11 to swivel and turn with respect to the wall-contacting surface during use.

When the massage device is sandwiched between a support surface (such as the wall illustrated in FIGS. 4-6) and the user, with the head point 4 in contact with the user's body, the user's bodyweight can be controllably and adjustably applied against the head point. At the same time, the user's bodyweight applied to the massage device is applied to the rest pivot to generally stabilize the rest pivot against sliding movement on the support surface. Owing to the mechanical advantage produced by the location of the rest pivot close to the head point's position on the main body, and relatively far from the handle region, a very small degree of pivoting force must be applied by the user against the handle region to exert a deeply penetrating force by the head point 4 against the user's body. By easily locating the head point at a desired position on the user's body in a tactile manner, leaning into the head point and exerting a small degree of pivoting force on the massage device's handle, the user can effectively apply deep tissue pressure with a single hand or arm and with minimal body strength so that the user's hand, wrist, arm, shoulder and back muscles are not strained.

The rest pivot can be an integral part of the main body 11, or attached to the main body either permanently or detachably. When “integral”, it may formed as part of the main body 11 as, for example, a part of a mold used to make the body. Alternatively, it may be relatively permanently affixed to the main body by mechanical means or mechanical or chemical bonding in a manner rendering it impractical, unlikely or impossible for a user to remove.

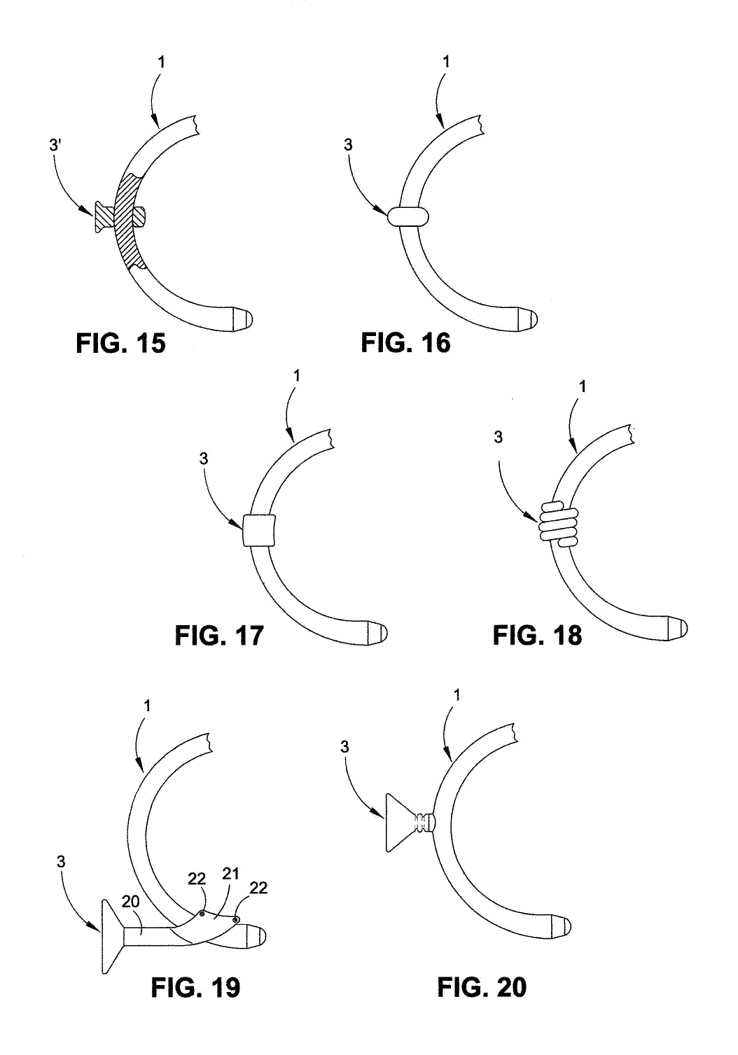

It is also possible to configure the rest pivot as a movable component whose position on the massage device can be adjusted as desired by the user. Examples of such rest pivot configurations are illustrated in FIGS. 15-19 herein. FIG. 15 is a fragmented side view in partial section of the massage device's main body wherein the rest pivot 3′ (also shown in section) is formed as part of a sleeve that can be slid into a desired position on the main body. The sleeve and rest pivot are preferably formed from an elastomeric material dimensioned so that the sleeve frictionally engages the outer surface of the main body sufficiently to maintain its position during use while permitting a user to reposition or remove the sleeve as desired. Exemplary materials from which the sleeve can be formed are rubber, vinyl foam, polyurethane foam, neoprene, neoprene foam, silicon and santoprene or compounds thereof. Alternatively, the rest pivot function can be provided by an appropriately dimensioned O.D. of a generally cylindrical sleeve, such as illustrated in FIG. 17, or of a more ring-shaped sleeve such as that illustrated in FIG. 16, or can be formed by wrapping multiple layers of tape around the massage device's body to obtain a shape similar to those illustrated in FIGS. 16-17.

Other rest pivot configurations are illustrated and described in the '144 Application, which is incorporated herein by reference.

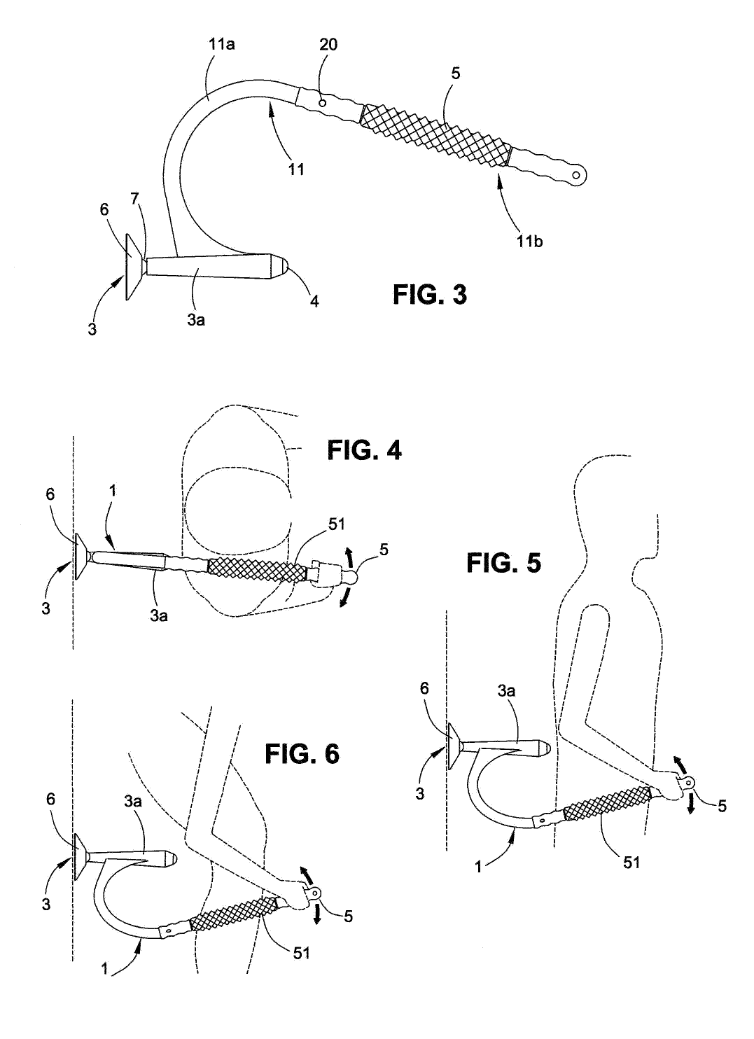

FIG. 3 is a side elevation view in schematic illustrating a novelly modified massage device. In FIG. 3, the modification is made to a “rest pivot” type device similar to that illustrated and described in the '144 Application. Those of ordinary skill in the art will recognize that the modification can also be made to trigger point devices having no rest pivot, including but not limited to the device illustrated in FIG. 2. All such devices are within the scope of the intended modification.

As shown in FIG. 3, the modified massage device comprises a generally “J”-shaped main body 11 having a body-contacting head point 4 at one end (the “head end”), and a handle region 11b adjacent the other end. At least a part of the handle region 11b is formed by a roller mechanism 5 and can be configured to be detachable from the remainder of the device. FIG. 3 illustrates such a configuration; the main body 11 can be bifurcated into two body segments 11a, 11b coupled together by a releasable locking mechanism 20 that allows the handle/roller portion to be separated from the remainder of the device and to be securely attached as desired.

When attached, the roller mechanism is simply part of the handle portion of the device, as illustrated in FIGS. 4-6, for example, where a person using the device is illustrated as having placed the device at the desired area between his/her back and the wall so that the massage head-point 4 applies pressure to the desire (treated) spot on the user's body. As respectively illustrated in FIGS. 4-6, the handle of the massage device can be pivoted about the rest pivot, when the rest pivot is secured against the wall by the user's bodyweight during use, to roll the roller mechanism generally horizontally along the shoulders (FIG. 4), generally vertically along the upper body or thighs (FIG. 5) and generally vertically along the lower legs (FIG. 6). It should be noted that the massage device may be generally “S”-shaped (as shown in FIGS. 1-2) or generally “J”-shaped so long as the roller portion of the handle region is generally straight.

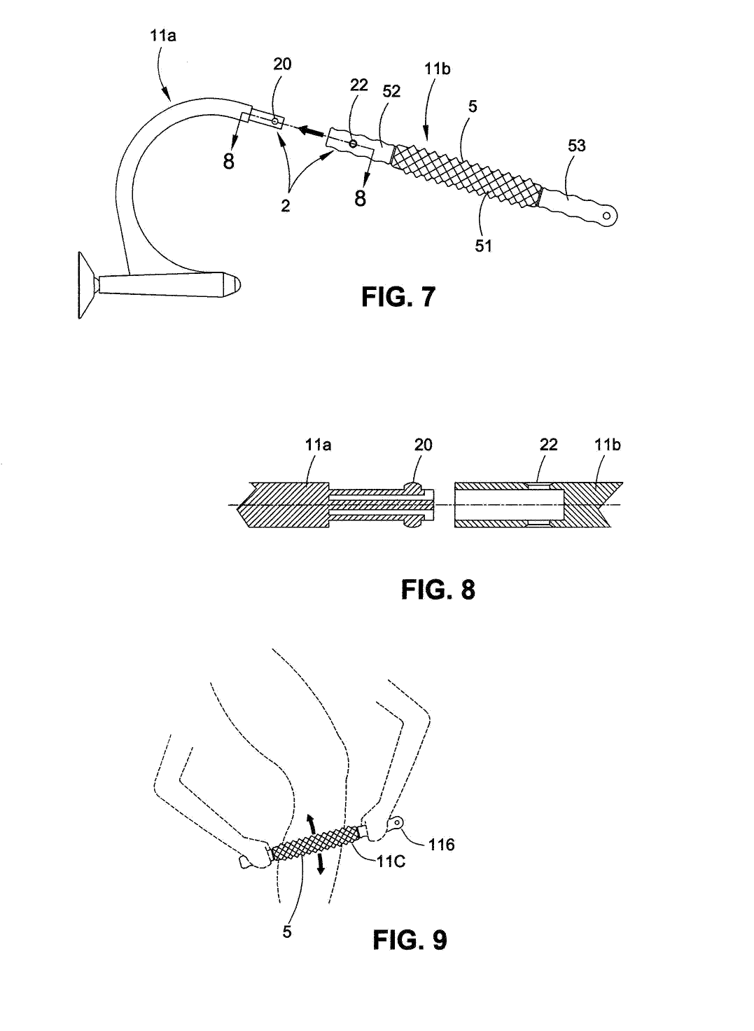

FIG. 7 is a right side elevation view in schematic of the modified massage device, showing the handle portion 11b detached from body segment 11a. As illustrated in FIG. 9, the user can then grasp both ends of the detached handle portion, and roll the roller 5 along the muscles to be relaxed, soothed and/or loosened. Consequently, the user needs only a single massage device to perform both trigger point and rolling massages, avoiding the need to purchase and store two separate devices. Moreover, those working out in gyms and health clubs can avoid the inconvenience and inefficiency of having to obtain a first massage device, return it to place, and then locate an available second type to use.

Examples of locking mechanisms are illustrated in FIG. 8, wherein a leading end portion of body segment 11a fits within a leading tubular end portion of body portion 11b. A cantilevered button 20 is carried by the end portion 11a and is deflected inward by the interior walls of the leading portion of body segment 11b as the two body segments are fit together. The cantilever provides a spring bias that causes the button 20 to emerge from a hole 22 in the tubular portion of body segment 11b to thereby releasably lock the two segments together much like the releasably securing mechanism commonly found in the poles of beach umbrellas. Manually depressing the button down into the hole permits the two body segments to be separated as with such beach umbrella poles. A single button can be provided, or two (preferably circumferentially opposite) buttons can be used with respective mating holes as illustrated in FIG. 8. Other known configurations of spring-loaded buttons and mating holes can be employed, or mating screw threads can be provided that permit one body segment to be screwed into and out of the other. Further, a “push and twist” coupling can be employed instead, utilizing one or more lugs protruding generally diametrically from one body segment that mates with one or more tracks formed internally in the mating segment in such a way that pushing and twisting one of the segments vis-à-vis the other results in a coupling of the two, while a twisting (in the opposite direction) and pulling permits their separation.

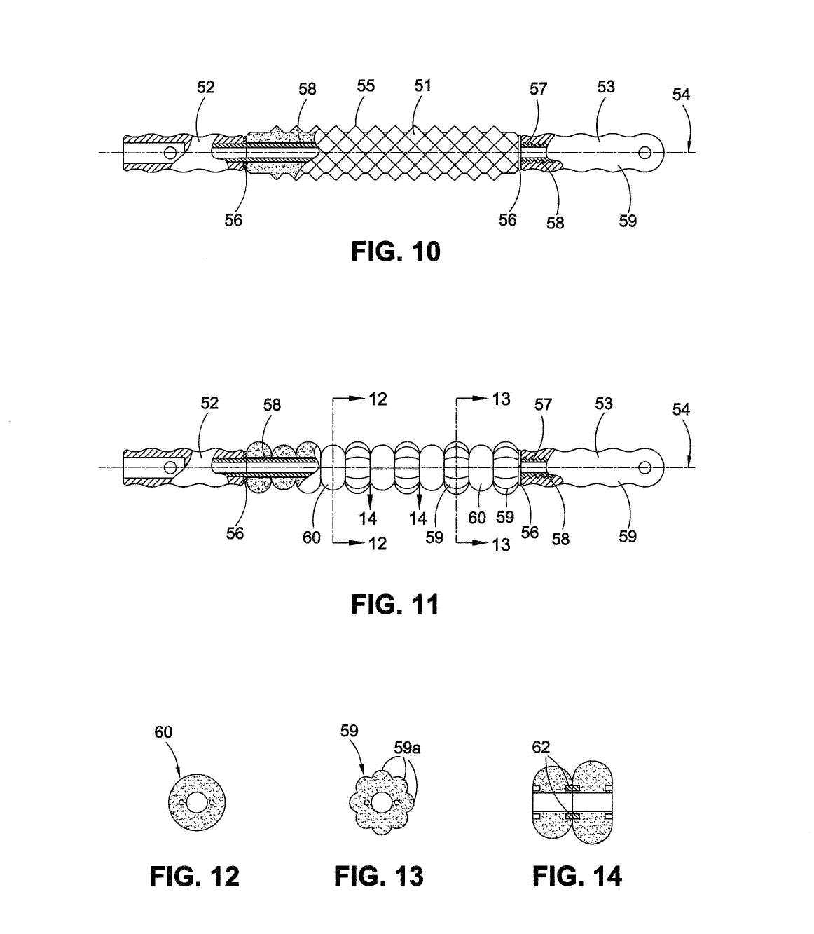

The roller 5 can have any of a number of configurations which comprise a rotatable tissue-compressing surface member 51 extending between two manually graspable handle regions 52, 53, one of which (region 52) being insertable into the main body segment 11a as described earlier. As illustrated in FIG. 10, the tissue-compressing surface member 51 rotates about a generally longitudinal axis 54 and is preferably mounted about a generally cylindrical rod 58 or other substrate for that purpose. The rod 58 may be solid or tubular, and provides the structural integrity of the main body segment 11b and, therefore, the roller mechanism 5. The tissue-compressing surface 51 illustrated in FIG. 10 includes a series of ridges 55 that apply pressure to the muscles over which it rolls. The rotating tissue-compressing surface is preferably separated from the relatively non-rotating handle regions 52, 53 by respective washers 56. The non-insertable handle region 53 is conveniently provided with a relatively ergonomic, internally threaded grip surface member 59 that is screwed onto an externally threaded member 57 extending axially from the roller mechanism. Preferably, the rod 58 is simply dimensioned to protrude axially from the roller mechanism, with its protruding end being externally threaded. The washers 56 are thereby captured to provide a low friction interface between each end of the roller 51 and the respective handle region 52, 53.

FIG. 11 illustrates another example of a tissue-compressing surface configuration wherein a plurality of generally annular disks 59 having a scalloped outer surface, e.g., an outer surface comprising a series of rounded projections 59a with notches between them. A generally annular disk 60 of relatively smaller diameter is positioned interjacent each pair of the disks 59 to provide a rounded skin-contacting surface within the notches to control the force of the projections 59a against the user's muscles as the roller is rolled over the muscle.

The disks 59, 60 can be individually mounted for rotation about the rod 58 (FIG. 11) or other substrate for rotation about the axis 54, or the plurality of the disks can be secured together, as by pins 62 (FIG. 14) extending between adjacent disks to enable the rolling surface to rotate, and to be mounted and removed from the assembly as an integral piece rather than independently.

Those of ordinary skill in the art will appreciate that various material of various densities can be employed, and that rolling surfaces of various shapes and textures can be provided without departing from the scope of the invention. The manually graspable handles of the roller assembly can be attached permanently to the rod, or at least one can be removable to enable the roller (and/or its rolling surface) to be changed.

As described in the '144 Application and earlier herein, the rest pivot of those self-massage devices employing one can be removably secured to the body. Other rest pivot configurations are illustrated herein by way of example in FIGS. 21-27. As illustrated in FIGS. 21-27, the base of the rest pivot can be provided with a stem 70 that fits within a generally tubular portion of an arm 73a that extends from the main body segment 11b, where it is secured by the force of the user's body pressing against the wall (FIG. 4-6). Alternatively, it may be magnetically secured within the arm by the coupling of a magnet 72 in the arm, the base (or its stem) with magnetically-responsive material 74 in the other of the arm and the base (or stem) as illustrated by way of example in FIGS. 21-24.

The detachable attachment of the rest pivot can alternatively be accomplished by providing the stem 70 and arm 73a with mating threads that enable the rest pivot be screwed into or onto the arm and unscrewed therefrom. Other mechanical couplings can be provided that render the rest pivot releasably secure within the body segment 11b as well. For example, a locking mechanism similar to locking mechanism 20 (FIGS. 3, 7-8) can be employed. Alternatively, a “bayonet” structure can be used as illustrated in FIG. 25-27 wherein interlocking shoulders 76, 78 of male and female connectors, respectively, are used. The configuration shown in FIGS. 26 and 27 can be structured to permit easy detachment of the rest pivot by, for example, enabling the male connector's shoulders 78 to be inwardly deflected to pass around the female connector's shoulders 76 as the rest pivot is withdrawn from the arm 73a by making the male extension resiliently and inwardly deformable by when squeezed by the user.

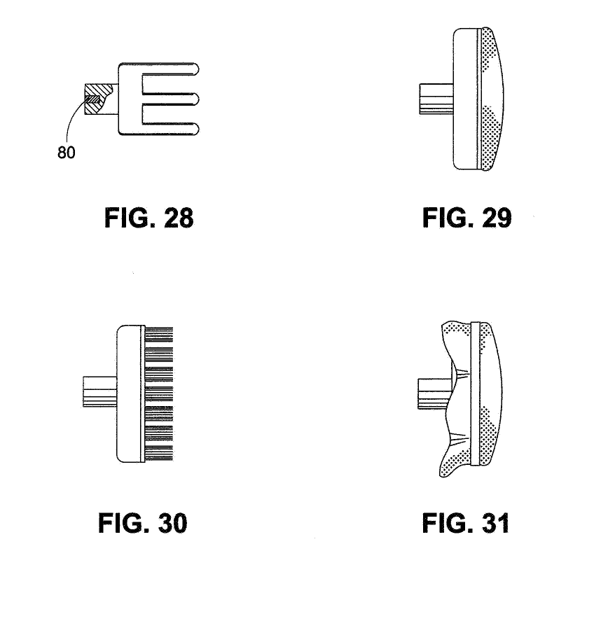

The releasably-securing mechanisms described above can also be used at the head point end of the body to provide detachable and/or interchangeable heads points. Changeable head points permit the device's head point to be used for different applications: e.g., for tissue compression (as exemplified by the convex surface illustrated at “4” in FIG. 3), as a scratcher (FIG. 28), a lotion-applicator (FIG. 29), a brush (FIG. 30), a wash cloth (FIG. 31), etc.

By way of example, an internal magnet 80 is illustrated within the scratcher of FIG. 28 which can magnetically couple to the massage device via a magnet within the head point end of the massage device body. The head points of FIGS. 29-31 can accordingly be provided with magnets as well, for magnetic attachment to, and easy decoupling from, the massage device.

Although the present invention and its advantages have been described in detail, it should be understood that various changes, substitutions and alterations can be made herein without departing from the spirit and scope of the invention as will be defined by appended claims.

I claim:

1. A massage device comprising:
a main body having a body-contacting head point adjacent one end and a manually grippable handle region adjacent the other end, the body shaped to permit a user to reach the back of his/her body with the head point when the handle region is at the user's front or side; and
a rest pivot extending from the main body and terminating at a distal end in a support-contacting face, the rest pivot being positioned with respect to the head point so that when the rest pivot is sandwiched between a support surface and the user with the head point in contact with the user's body and the handle region positioned for contact by the user's hand, (a) the user's bodyweight applied to the rest pivot generally stabilizes the rest pivot against sliding movement on the support surface (b) the user's body weight can be controllably and adjustably applied against the head point by the user, and (c) any pivoting force about the rest pivot applied by the user's hand to the handle region is substantially less than the force exerted against the user's body by the head point,
said head point being selected from the group consisting of a tissue-compression surface, a back-scratcher, a lotion applicator, a wash cloth and a brush.

2. The massage device of claim 1 wherein at least a plurality of the tissue-compression surface, the back-scratcher, the lotion applicator, the wash cloth and the brush are releasably securable to said one end of the massage device.

3. The massage device of claim 1 wherein the rest pivot is formed as part of a sleeve that is bonded to the main body.

4. The massage device of claim 1 wherein the rest pivot is held to the body of the massage device by a sleeve configured to be slid along the main body to a desired position.

5. The massage device of claim 1 wherein the rest pivot is a sleeve configured to be slid along the main body to a desired position.

6. The massage device of claim 4 wherein the sleeve is formed from an elastomeric material dimensioned to engage the outer surface of the main body sufficiently to maintain its position during use while permitting a user to reposition or remove the sleeve as desired.

7. The massage device of claim 6 wherein the sleeve is formed from a material selected from the group consisting of rubber, vinyl foam, polyurethane foam, neoprene, neoprene foam, silicon and santoprene and compounds thereof.

8. The massage device of claim 4 wherein the rest pivot is formed from the same material as the sleeve.

9. The massage device of claim 4 wherein the sleeve is generally ring-shaped.

10. The massage device of claim 4 wherein the sleeve is generally cylindrical in shape.

11. The massage device of claim 1 wherein the manually grippable handle region includes a roller mechanism having an axially-extending roller surface.

12. The massage device of claim 9 wherein the handle region is reversibly detachable from the remainder of the device in such a way that the roller surface is disposed between two non-rotating manually graspable end portions configured to be held by the user while rolling the rolling surface along the user's body.

13. The massage device of claim 10 including a locking mechanism for releasably securing the handle region to the remainder of the device and user-operable to release the handle region from the remainder of the device.

14. For use with a massage device having
a main body with a body-contacting head point adjacent one end selected from the group consisting of a tissue-compression surface, a back-scratcher, a lotion applicator, a wash cloth and a brush, and
a manually grippable handle region adjacent the other end, the body being shaped to permit a user to reach the back of his/her body with the head point when the handle region is at the user's front or side,
a rest pivot component comprising
a sleeve dimensioned to be slid along the main body to a desired sleeve position
a rest pivot integral with or affixed to said sleeve in such a way that the rest pivot is held to the main body of the massage device by the sleeve so as to extend distally from the main body at a desired pivot position, the rest pivot terminating at a distal end in a support-contacting face, and being positioned by the sleeve with respect to the head point so that when the rest pivot is sandwiched between a support surface and the user with the head point in contact with the user's body and the handle region positioned for contact by the user's hand, (a) the user's bodyweight applied to the rest pivot generally stabilizes the rest pivot against sliding movement on the support surface (b) the user's body weight can be controllably and adjustably applied against the head point by the user, and (c) any pivoting force about the rest pivot applied by the user's hand to the handle region is substantially less than the force exerted against the user's body by the head point.
